(19) United States
(12) Patent Application Publication
(10) Pub. No.: US 2001/0024300 A1
(43) Pub. Date: Sep. 27, 2001

(54) Sensor chip, image reading sensor, and electronic device

(75) Inventors: Kazuhiko Sasahara, Sagamihara-shi (JP); Takeshi Mikura, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Kabushiki Kaisha Toshiba, Kawasaki-shi (JP)

(21) Appl. No.: 09/816,081

(22) Filed: Mar. 26, 2001

(30) Foreign Application Priority Data
Mar. 27, 2000 (JP) 86552/2000

(51) Int. Cl. H04N 1/04

(52) U.S. Cl. 358/482

(57) ABSTRACT

A sensor chip, an image reading sensor and an electronic device, which are capable of preventing poor image readings, are provided. The sensor chip is constructed such that the image reading sensor is constituted by mounting a plurality of sensor chips on a sensor substrate, and is provided with a notch at a lower corner of an end portion which faces with other sensor chip. The image reading sensor is constituted by mounting a plurality of sensor chips on a sensor substrate, and each sensor chip is provided with a notch at a lower corner of the end portion which faces other sensor chip. The electronic device contains the image reading sensor, which is constituted by mounting a plurality of sensor chips on a sensor substrate, and each sensor chip is provided with a notch at a lower corner of the end portion which faces other sensor chip.

### BACKGROUND OF THE INVENTION

1. Field of the Invention

The present invention relates to an electronic device containing an image reading sensor comprising sensor chips for sensing light and converting the light to an electrical signal, and also to the image reading sensor and the sensor chip.

2. Description of the Related Art

Conventionally, image reading sensors used in reading apparatuses such as copiers and OCR (optical character readers) are configured as shown in FIG. 17.

Specifically, an image reading sensor 102 is constituted by a plurality of CCD (charge coupled device) sensor chips 103 disposed in a straight line on a sensor substrate 104. The individual CCD sensor chips 103 are bonded to the sensor substrate 104 so as to be very close to each other.

The abovementioned CCD sensor chip 103 has the form of a rectangular parallelepiped as shown in FIGS. 18(a) to 18(c); a sensor face 103h is formed on its surface. A multiplicity of reading pixels (CCD elements) 103C for sensing light and converting the light to an electrical signal are formed on this sensor face 103h.

The CCD sensor chips 103 are bonded, by their back sides 103r serving as the mounting face, to the sensor substrate 104 using die bonding paste 104p, with their end portions 103t facing each other.

Here, the space between the end portions 103t of adjacent CCD sensor chips 103 is set at 10 to 20 μm.

Furthermore, the abovementioned sensor substrate 104 and each CCD sensor chip 103 are electrically connected by wire bonding, using a gold wire 106, electrode terminals (not shown) of the sensor face 103h of the CCD sensor chip 103 to electrode terminals (not shown) of the sensor substrate 104.

With the image reading sensor 102 configured as discussed above, in the manufacturing process thereof, when receiving a bonding pressure from above during the bonding operation, the die bonding paste 104p may leaks out from between the end portions 103t of adjacent CCD sensor chips 103 and partially covers the sensor face 103h of the CCD sensor chips 103 as shown in FIG. 19 (a).

When the leaked die bonding paste 104p covers the reading pixels 103C formed on the sensor face 103h as shown in FIG. 19 (b), the reading pixels 103C cannot sense the incident light and poor readings may occur.

When poor image readings occur with individual CCD sensor chips 103 in this way, image readings performed by the image reading sensor 102 constituted by the CCD sensor chips 103 become poor and the image reading function of an electronic device containing the image reading sensor 102 is also impaired.

On the other hand, according to Japanese Patent Application No. 8-129470 (CCD chip and method for forming CCD chip), a constitution is disclosed wherein a step surface, formed lower than the effective pixel area and for positioning by abutting the component side contact surface, is provided outside of the effective pixel area on a CCD chip on which components are mounted with the surface thereof used as a reference level.

However, according to the abovementioned constitution, the step surface is provided on the effective pixel area surface side which is the opposite side to the substrate-mounting surface of the CCD chip, so that stress applied to the effective pixel area is released and furthermore the components are positioned with respect to the CCD chip. Therefore, the abovementioned constitution does not resolve the problems discussed above.

### SUMMARY OF THE INVENTION

The present invention was developed in view of the situation discussed above and it is an object of the present invention to provide a sensor chip, image reading sensor, and electronic device with which it is possible to prevent poor image readings caused by the leakage of the die bonding paste.

The sensor chip of claim 1 is a sensor chip which is rectangular in plane shape and has reading pixels on a surface thereof, and which is constructed such that an image reading sensor is constituted by mounting a plurality of such sensor chips in a straight line on a sensor substrate with an end portion of the sensor chip being placed to face with an end portion of other sensor chip; in which a notch is provided at a lower corner of the end portion of the sensor chip which faces other sensor chip.

With this constitution, even if the sensor chip receives a bonding pressure from above during the bonding operation in the manufacturing process and the die bonding paste leaks out from between the back side (mounting face) of the sensor chip and the sensor substrate, the die bonding paste will enter and stay within the notches formed in the sensor chips. As a result, the die bonding paste does not leak onto the sensor face of the sensor chips and adhere to the reading pixels, and the sensor chip is prevented from causing poor image readings.

The image reading sensor of claim 6 is an image reading sensor comprising a plurality of sensor chips, each of which is rectangular in plane shape and has reading pixels on a surface thereof, mounted in a straight line on a sensor substrate with an end portion of the sensor chip being placed to face with an end portion of other sensor chip; in which a notch is provided at a lower corner of the end portion of the sensor chip which faces other sensor chip.

With this constitution, even if the sensor chips constituting an image reading sensor receive the bonding pressure from above during the bonding operation in the manufacturing process and the die bonding paste leaks out from between the back side (mounting face) of the sensor chip and the sensor substrate, the die bonding paste will enter and stay within the notches formed in the sensor chips. As a result, the die bonding paste does not leak onto the sensor face of the sensor chips and adhere to the reading pixels, and the sensor chips will not cause poor image readings.

Accordingly, the image reading sensor constituted by the sensor chips can be prevented from poor image readings.

The electronic device of claim 11 is an electronic device containing an image reading sensor comprising sensor chips, each of which is rectangular in plane shape and has reading pixels on a surface thereof, mounted in a straight line on a sensor substrate with an end portion of the sensor chip being placed to face with an end portion of other sensor chip; in which a notch is provided at a lower corner of the end portion of the sensor chip which faces other sensor chip.

With this constitution, even if the sensor chips constituting an image reading sensor receive a bonding pressure from above during the bonding operation in the manufacturing process and the die bonding paste leaks out from between the back side (mounting face) of the sensor chip and the sensor substrate, the die bonding paste will enter and stay within the notches formed in the sensor chips. As a result, the die bonding paste will not leak onto the sensor face of the sensor chips and adhere to the reading pixels, and the sensor chips will not cause poor image readings.

Accordingly, since the image reading sensor constituted by the sensor chips can be prevented from causing poor image readings, the image reading function of an electronic device containing the image reading sensor functions normally and a highly reliable electronic device can be attained.

### BRIEF DESCRIPTION OF THE DRAWINGS

FIG. 1 is a conceptual diagram showing an embodiment of an electronic device relating to the present invention;

FIGS. 2(a) and 2(b) respectively are a front view and perspective view showing a first embodiment of an image reading sensor in the electronic device in FIG. 1;

FIGS. 3(a) to 3(e) respectively are a plane view, front view, cross sectional view along line B-B, side view, and perspective view showing a first embodiment of the sensor chip in the image reading sensor shown in FIGS. 2(a) and 2(b) and relating to the present invention;

FIGS. 4(a) and 4(b) respectively are an enlarged front view and a cross sectional view along line C-C showing the image reading sensor in FIGS. 2(a) and 2(b);

FIGS. 5(a) and 5(b) respectively are a perspective view of the wafer before processing and a perspective view of the wafer after pattern formation, showing the manufacturing process of the sensor chip shown in FIGS. 3(a) to 3(e);

FIG. 6 is a perspective view of the polishing process of the back side of the wafer showing the manufacturing process of the sensor chip shown in FIGS. 3(a) to 3(e);

FIGS. 7(a) to 7(c) respectively are a perspective view showing the cutting from the back side of the wafer, a partially enlarged view of the back side of the wafer before cutting, and a partially enlarged view of the back side of the wafer after cutting, showing the manufacturing process of the sensor chip shown in FIGS. 3(a) to 3(e);

FIGS. 8 (a) to 8(c) respectively are a perspective view showing the cutting from the surface of the wafer, a partially enlarged view of the surface of the wafer before cutting, and a partially enlarged view of the surface of the wafer after cutting, showing the manufacturing process of the sensor chip shown in FIGS. 3(a) to 3(e);

FIGS. 9(a) and 9(b) respectively are a conceptual diagram showing a second embodiment of the sensor chip relating to the present invention and a partially enlarged front view showing a second embodiment of the image reading sensor using this sensor chip;

FIGS. 10(a) and 10(b) respectively are a perspective view showing a third embodiment of the sensor chip relating to this invention and a partially enlarged front view showing a third embodiment of the image reading sensor using this sensor chip;

FIGS. 11(a) and 11(b) are front views showing the manufacturing process for the third embodiment of the sensor chip relating to this invention; and FIG. 11(c) is a cross sectional view taken perpendicularly to the cutting direction of the wafer and blade, and showing the cutting process in the third embodiment of the sensor chip relating to this invention;

FIGS. 12(a) and 12(b) are horizontal cross sectional views of the blade used in the cutting process shown in FIG. 11(c);

FIGS. 13(a) and 13(b) respectively are a perspective view showing a fourth embodiment of the sensor chip relating to this invention and a partially enlarged front view showing a fourth embodiment of the image reading sensor using this sensor chip;

FIG. 14 is a cross sectional view taken perpendicularly to the cutting direction of the wafer and blade, and showing the cutting process in the fourth embodiment of the sensor chip relating to this invention;

FIGS. 15(a) and 15(b) respectively are a perspective view showing a fifth embodiment of the sensor chip relating to this invention and a partially enlarged front view showing a fifth embodiment of the image reading sensor using this sensor chip;

FIGS. 16(a) and 16(b) respectively are a perspective view showing a sixth embodiment of the sensor chip relating to this invention and a partially enlarged front view showing a sixth embodiment of the image reading sensor using this sensor chip;

FIG. 17 is a perspective view showing a conventional image reading sensor;

FIGS. 18(a) to 18(c) respectively are a plan view, a front view and a side view of a conventional CCD sensor chip; and

FIGS. 19(a) and 19(b) respectively are a partially enlarged front view and a partially enlarged plan view of the conventional image reading sensor.

### DESCRIPTION OF THE PREFERRED EMBODIMENTS

The preferred embodiments of the present invention are explained in detail below with reference to the drawings.

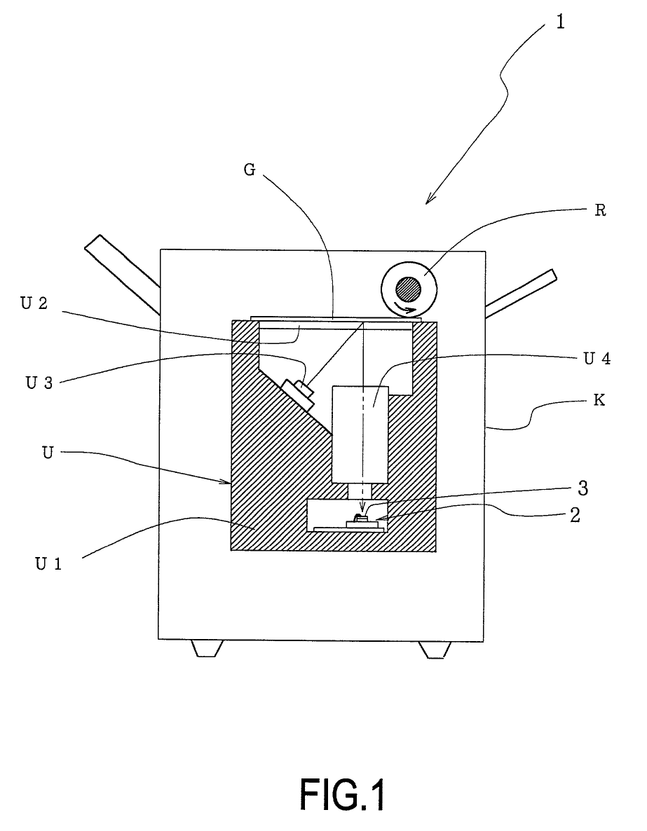

FIG. 1 shows a copier 1 (electronic device) to which the present invention is applied. The copier 1 in a first embodiment contains an image reading unit U within a housing K.

The image reading unit U in the first embodiment is provided with a base frame U1 extending in the direction orthogonal to the paper surface in FIG. 1. An original platen glass U2 is attached to the top part of the base frame U1, and a light source U3 and image-forming lens U4 are arranged within the base frame U1 to extend in the longitudinal direction thereof.

With the copier 1 of the configuration as discussed above, an operation of reading the text and image information on an original G is effected by a method in which the original G conveyed by an original conveying roller R on the original platen glass U2 of the image reading unit U is irradiated with light from the light source U3, and the light reflected from the original G is image-formed onto a CCD sensor chip 3 (sensor chip) of an image reading sensor 2 using an image-forming lens U4.

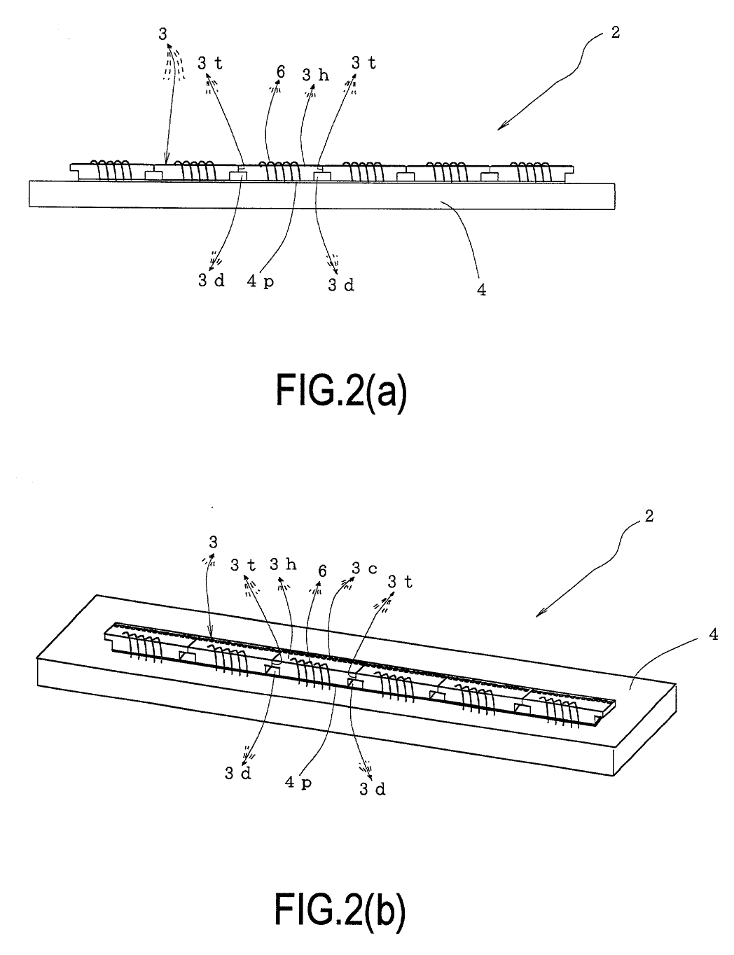

As shown in FIGS. 2(a) and 2(b), the image reading sensor 2 inside the image reading unit U is constituted by a plurality of CCD sensor chips 3 arranged in a straight line on a sensor substrate 4. The individual CCD sensor chips 3 are bonded onto the sensor substrate 4 while being placed very close to each other.

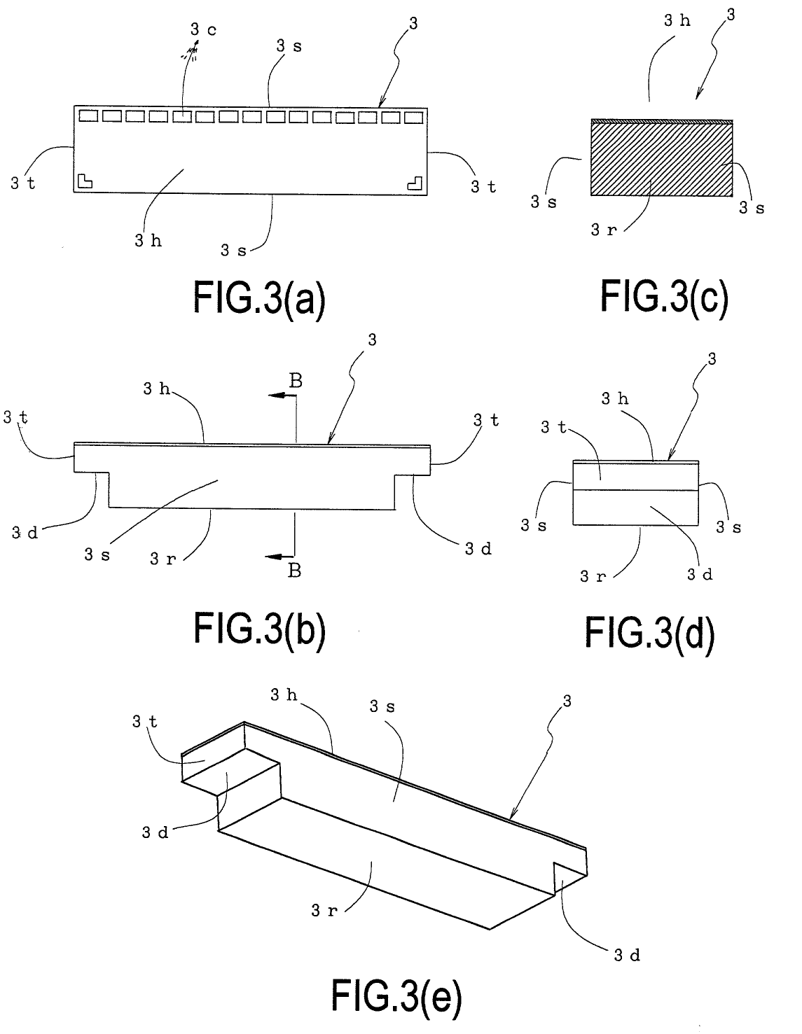

The abovementioned CCD sensor chips 3 are formed by cutting apart an unprocessed wafer (discussed below). As shown in FIGS. 3(a) to 3(e), the CCD sensor chip 3 is of a substantially rectangular parallelepiped form and has a sensor face 3h formed on the surface thereof. A plurality of reading pixels (CCD elements) 3C for sensing light and converting the light to an electrical signal are formed on the sensor face 3h.

A back side 3r, as the mounting face, of each CCD sensor chip 3 is bonded using die bonding paste 4p onto the sensor substrate 4, with end portions 3t of the CCD sensor chips being placed opposite to each other.

Here, the space between the end portions 3t of adjacent CCD sensor chips 3 is set at 10 to 20 μm.

Furthermore, the abovementioned sensor substrate 4 and each CCD sensor chip 3 are electrically connected by wire-bonding, using a gold wire 6, electrode terminals (not shown) of the sensor face 3h on the CCD sensor chip 3 and electrode terminals (not shown) on the sensor substrate 4.

Each side surface 3s of the abovementioned CCD sensor chips 3 is flat, while a step-shaped notch 3d having two flat surfaces is formed at the lower corners of the opposite end portions 3t (the left and right ends in FIGS. 3(a) and 3(b)).

As discussed below, this notch 3d is provided to define a space for receiving the die bonding paste 4p which has leaked out from between the back side 3r (mounting face) of the CCD sensor chip 3 and the sensor substrate 4 due to the bonding pressure applied during the bonding operation in the manufacturing process.

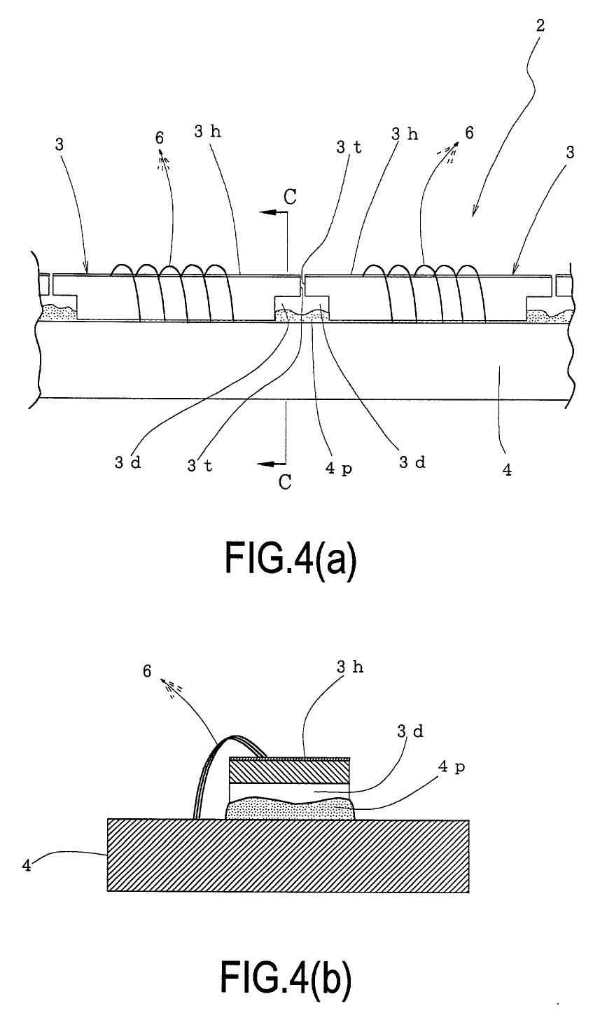

As shown in FIGS. 4(a) and 4(b), with the image reading sensor 2 of the abovementioned configuration, even if the CCD sensor chip 3 receives the bonding pressure from above during the bonding operation in the manufacturing process and the die bonding paste 4p leaks out from between the back side 3r (mounting face) of the CCD sensor chip and the sensor substrate 4, the die bonding paste 4p will enter and be contained within the notch 3d formed in the CCD sensor chip 3. As a result, the die bonding paste 4p will not leak onto the sensor face 3h of the CCD sensor chip 3.

Consequently, the die bonding paste 4p will not adhere to reading pixels 3C formed on the sensor face 3h of the CCD sensor chip 3 and poor image readings by the CCD sensor chip 3 do not occur.

Because poor image readings do not occur with the CCD sensor chips 3, the image reading sensor 2 constituted by the CCD sensor chips 3 is also prevented from causing poor image readings.

Furthermore, because poor image readings do not occur with the CCD sensor chips 3, the image reading sensor 2 constituted by the CCD sensor chips 3 is prevented from causing poor image readings, and therefore, the copier 1 containing the image reading sensor 2 is also prevented from causing poor image readings and is enabled to perform the copying function normally.

Because the notches 3d in the CCD sensor chips 3, which are formed only in the lower corners of the end portions 3t, will not greatly reduce the area of the back side 3r serving as the mounting face, a sufficient bonding area is ensured between the sensor chips 3 and the sensor substrate 4 and the bonding strength of the CCD sensor chips 3 to the sensor substrate 4 does not decrease.

In this way, the CCD sensor chips 3 are bonded to the sensor substrate 4 with sufficient bonding strength. As a result, the image reading sensor 2 constituted by a plurality of CCD sensor chips 3 bonded to the sensor substrate 4 is ensured to have sufficient structural strength.

Furthermore, the copier 1 containing the image reading sensor 2 for which sufficient structural strength is ensured as discussed above is enabled to have improved reliability in operation as an electronic device.

The method for manufacturing the CCD sensor chips 3 discussed above is explained below.

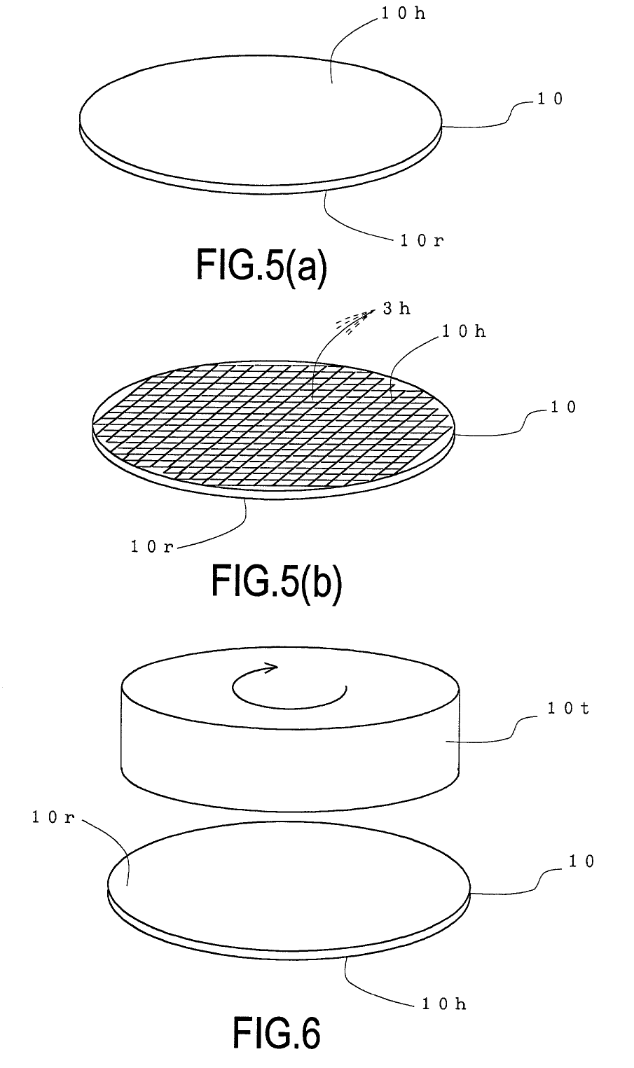

As shown in FIG. 5(a), a wafer 10 that is the material for the CCD sensor chips 3 is prepared. As shown in FIG. 5(b), the pattern that will become the sensor face 3h of the CCD sensor chips 3 discussed above is formed on a surface 10h of the wafer 10.

Next, as shown in FIG. 6, a back side 10r (the surface that will constitute the mounting face of the CCD sensor chips 3) of the wafer 10 is polished using a grinding stone lot.

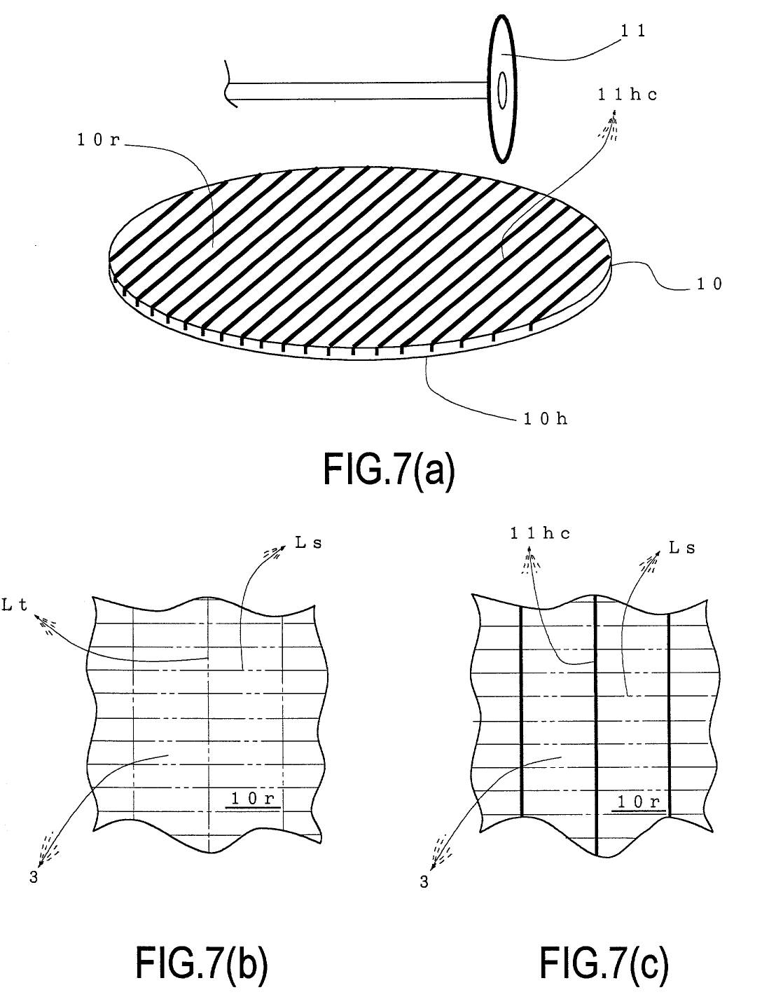

Afterwards, as shown in FIG. 7(a), from the back side 10r of the wafer 10, the wafer 10 undergoes wide half cut dicing using a back side blade 11 having a large width part way through the thickness of the wafer 10 at locations corresponding to the end portions 3t of the CCD sensor chips 3.

In other words, as shown in FIG. 7(b), half cut dicing is performed on the back side 10r of the wafer 10 along cutting lines Lt, from among the cutting lines Lt (virtual line) corresponding to the end portions 3t and cutting lines Ls (virtual line) corresponding to the side portions 3s of the CCD sensor chips 3, which divide the wafer 10 into the CCD sensor chips 3, so that, as shown in FIG. 7(c), half cut grooves 11hc are formed for forming the notches 3d (see FIGS. 3(a) to 3(e)) of the CCD sensor chips 3 discussed above.

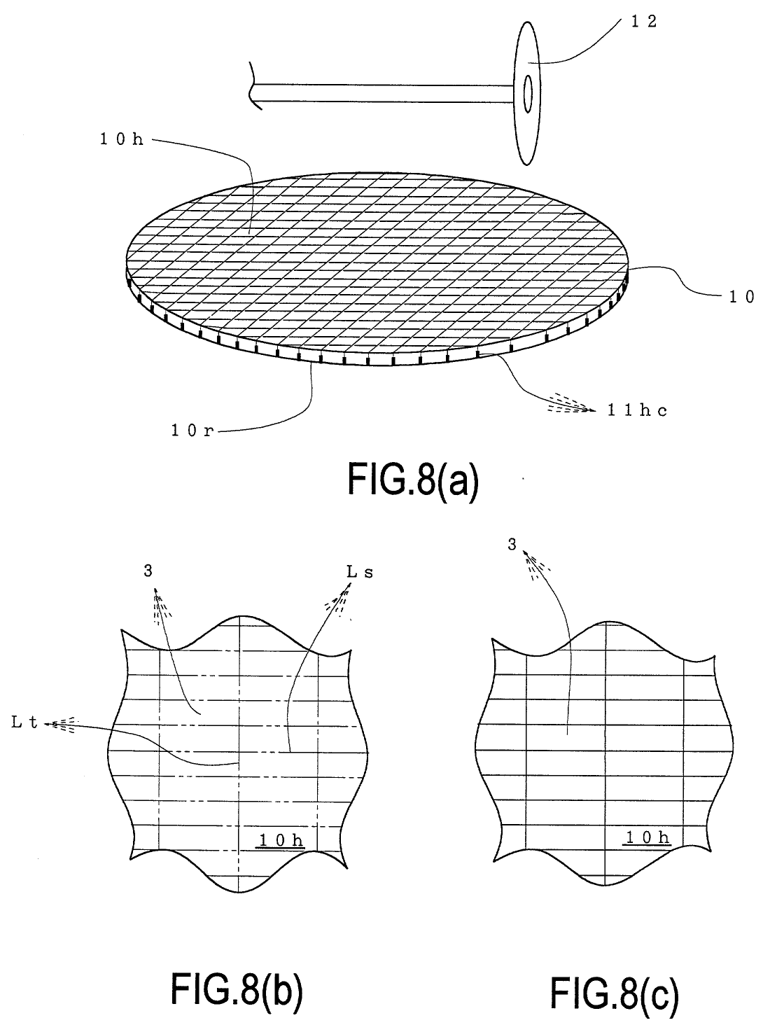

Next, as shown in FIG. 8(a), full cut dicing is performed from the surface 10h of the wafer 10 using a surface blade 12 that is narrower than the back side blade 11 discussed above and the wafer 10 is divided into individual CCD sensor chips 3.

In other words, as shown in FIG. 8(b), full cut dicing is performed from the surface 10h along the cutting lines Ls and cutting lines Lt for dividing the wafer 10 into the CCD sensor chips 3 so that, as shown in FIG. 8(c), the wafer 10 is divided into individual CCD sensor chips 3.

With the manufacturing method discussed above, the notches 3d formed in the CCD sensor chips 3 are attained by half cut dicing of the wafer 10 during the manufacturing process from the back side 10r using the wide back side blade 11. As a result, the work for forming the notches can be facilitated greatly.

The embodiment discussed above was explained using an example of step-shaped notches as the notches in the end portions of the CCD sensor chips. However, the form of the notches may naturally be selected as appropriate.

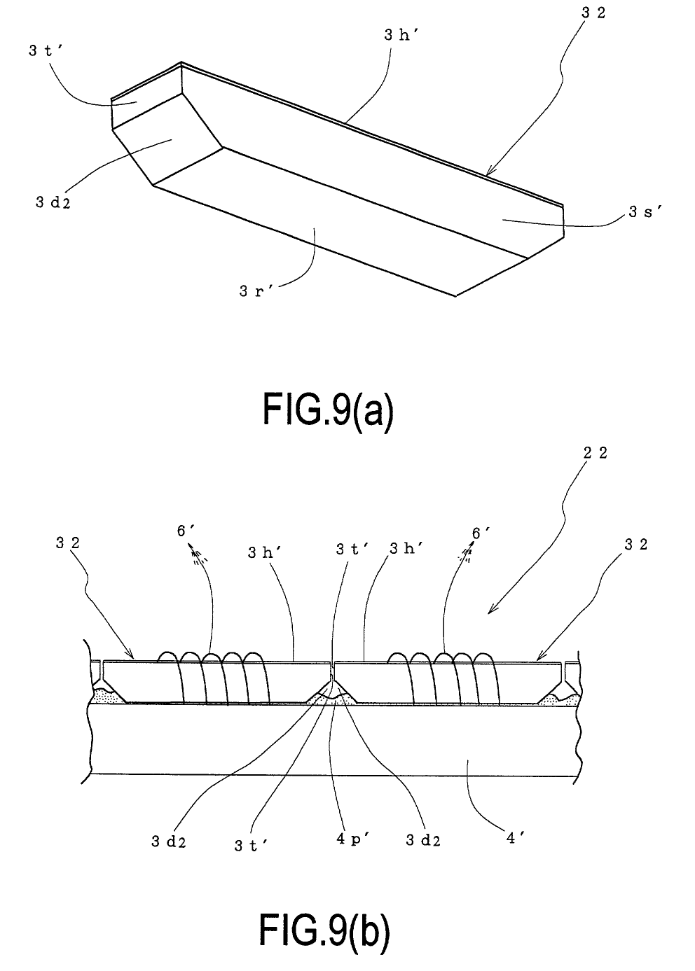

FIGS. 9(a) and 9(b) show a CCD sensor chip 32 that is the second embodiment of the invention and an image reading sensor 22 constituted from the CCD sensor chips 32 mounted on the sensor substrate 4′.

Specifically, in the CCD sensor chips 32 which constitute the image reading sensor 22 by mounting a plurality of the chips on the sensor substrate 4′ in a straight line with their end portions 3t′ close to one another, chamfered notched portions 3d2 having one inclined surface are formed in the lower corners of the end portions 3t′ which face the other adjacent CCD sensor chips 32.

The present embodiment is entirely the same as the first embodiment discussed above, except for having the notched portions 3d formed in the end portions 3t of the CCD sensor chip 3 changed to the chamfered notched portions 3d2. Because of this, the components other than these are indicated with an apostrophe attached to the respective reference numbers and a detailed explanation is omitted.

As shown in FIG. 9(b), even if the CCD sensor chip 32 receives the adhesive pressure from above during the adhesion operation in the manufacturing process and die bonding paste 4p′ leaks from between a back side 3r′ (mounting surface) of the CCD sensor chip 32 and a sensor substrate 4′, the die bonding paste 4p′ will enter and be held within the notched portion 3d2 formed in the CCD sensor chip 32. As a result, the die bonding paste 4p′ does not leak onto the sensor surface 3h′ of the CCD sensor chip 32.

Consequently, the die bonding paste 4p′ does not adhere to the reading pixels formed on a sensor surface 3h′ of the CCD sensor chip 32 and poor image readings will not occur in the CCD sensor chip 32.

Also, because the notched portions 3d2 in the CCD sensor chips 32 are formed only in the lower corners of the end portions 3t′, and the area of the back side 3r′ that is the mounting surface is not greatly reduced, a sufficient area for adhesion to the sensor substrate 4′ is ensured and the strength of the adhesion of the CCD sensor chips 32 to the sensor substrate 4′ does not decrease.

Accordingly, the CCD sensor chips 32, the image reading sensor 22, and the copier (electronic device) having the image reading sensor 22 exhibit the same merits as the those explained for the first embodiment.

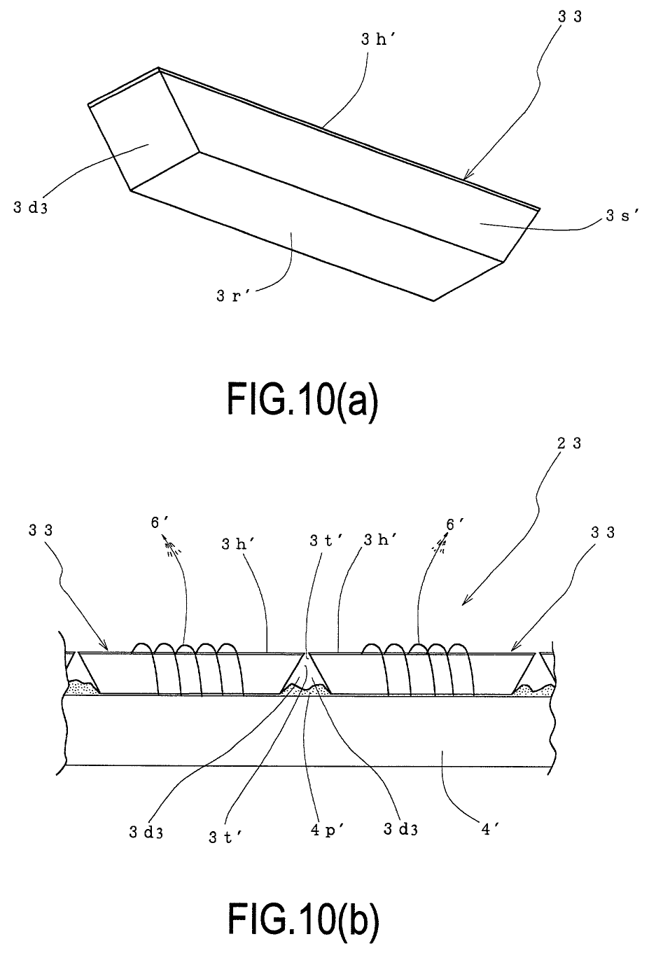

FIGS. 10(a) and 10(b) show a CCD sensor chip 33 that is the third embodiment, and an image reading sensor 23 constituted by the CCD sensor chips 33 mounted on the sensor substrate 4′.

As shown in FIGS. 10(a) and 10(b), the CCD sensor chips 33 in the third embodiment have chamfered notched portions 3d3 having a single inclined surface extending from the back side (mounting surface) 3r′ to the sensor surface 3h′, formed in the lower corners of end portions 3t′ which face other adjacent CCD sensor chips 33 when mounted on the sensor substrate 4′.

The present embodiment has exactly the same constitution as the second embodiment, except for the notched portions 3d3 discussed above, and therefore the same reference numbers are used for the components other than the notched portions and a detailed explanation is omitted.

The abovementioned CCD sensor chips 33 are manufactured with the following method.

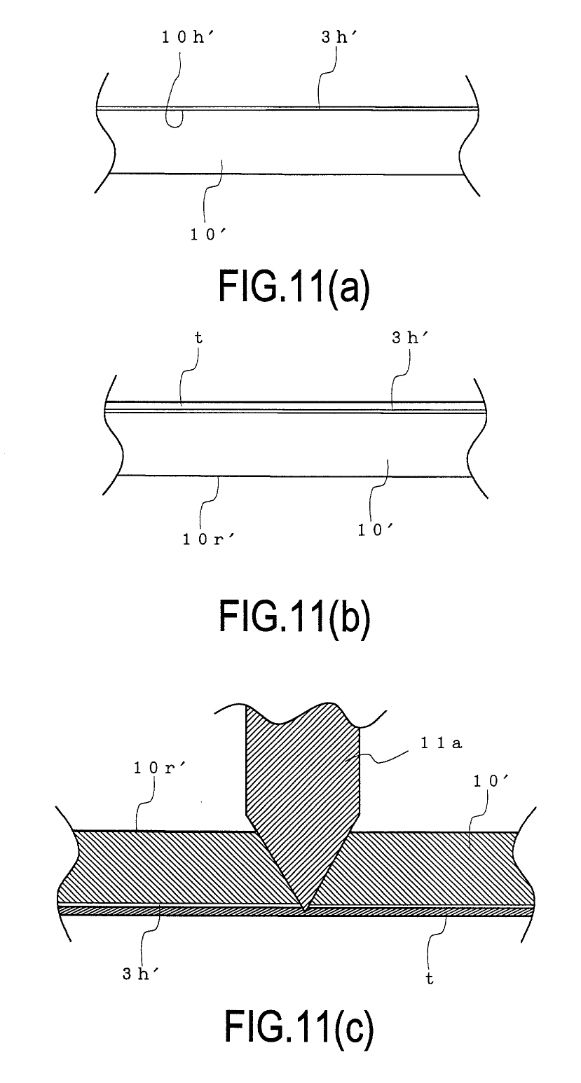

As shown in FIG. 11(a), a wafer 10′ that is the raw material for the CCD sensor chips 33 is prepared. The pattern that will become the sensor surface 3h′ of the CCD sensor chips 33 discussed above is formed on the surface 10h′ of the wafer 10′.

Next, as shown in FIG. 11(b), the back side 10r′ (the surface that will constitute the mounting surface of the CCD sensor chips 33) of the wafer 10′ is polished using a whetstone. Furthermore, a film t is adhered to the sensor surface 3h′ of the wafer 10′.

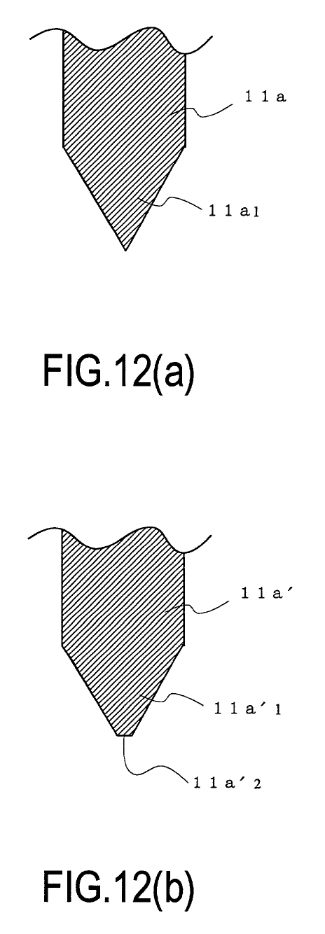

In order to form the chamfered notched portions 3d3 having a single inclined surface extending from the back side 3r′ to the sensor surface 3h′ in the lower corners of the end portions 3t′ of the CCD sensor chips 33 by means of a cutting process, a blade 11a having a cutting edge 11a1 with a wedged-shaped cross section, as shown in FIG. 12(a), is prepared.

Next, as shown in the cross sectional view taken perpendicularly to the cutting direction of the blade 11a and wafer 10′ in the cutting process of the wafer 10′ in FIG. 11(c), the wafer 10′ is divided into the CCD sensor chips 33 using the blade 11a to cut successively along prescribed cutting lines from the back side 10r′ of the wafer 10′, to which the film t is adhered, into the interior of the film t.

The film t is not cut completely through with the blade 11a in order to prevent the plurality of the CCD sensor chips 33 which have been cut apart from scattering around.

Moreover, when cutting the wafer 10′, it is also possible to use a blade 11a′ with a cutting edge 11a′1 having a wedge-shaped cross section wherein the tip is a flat surface 11a′2 as shown in FIG. 12(b), instead of the blade 11a (see FIG. 12(a)) having the wedge-shaped cross section wherein the tip of the cutting edge is pointed.

According to the present constitution, as shown in FIG. 10(b), even if the CCD sensor chip 33 receives the adhesive pressure from above during the adhesion operation in the manufacturing process and the die bonding paste 4p′ leaks from between the back side 3r′ (mounting surface) of the CCD sensor chip 33 and the sensor substrate 4′, the die bonding paste 4p′ will enter and be held within the notched portion 3d3 formed in the CCD sensor chip 33. As a result, the die bonding paste 4p′ does not leak onto the sensor surface 3h′ of the CCD sensor chip 33.

Consequently, the die bonding paste 4p′ does not adhere to the reading pixels formed on the sensor surface 3h′ of the CCD sensor chip 33 and poor image readings by the CCD sensor chip 33 do not occur.

Also, because the notched portions 3d3 in the CCD sensor chips 33 are formed only in the lower corners of the end portions 3t′, and does not reduce the area of the back side 3r′ that is the mounting surface greatly, a sufficient area for adhesion to the sensor substrate 4′ is ensured and the strength of the adhesion of the CCD sensor chips 33 to the sensor substrate 4′ does not decrease.

Accordingly, the CCD sensor chips 33, the image reading sensor 23, and the copier (electronic device) including the image reading sensor 23 have the same merits as the merits explained for the first embodiment.

In addition, according to the manufacturing method for the CCD sensor chips 33 discussed above, the wafer is cut into the CCD sensor chips 33 by cutting from the back side 10r′ of the wafer using the blade 11a or blade 11a′ in the process for cutting the wafer 10′. As a result, the cutting operation in the manufacturing process is simplified and manufacturing costs are reduced.

Furthermore, of the blade 11a′ with the cutting edge 11a′1 the tip of which has the wedge-shaped cross section with the flat surface 11a′2 is used in the process for cutting the wafer 10′, the number of times the blade has to be replaced is reduced and manufacturing costs are reduced because such blade has stronger cutting edge and the blade has a longer life span.

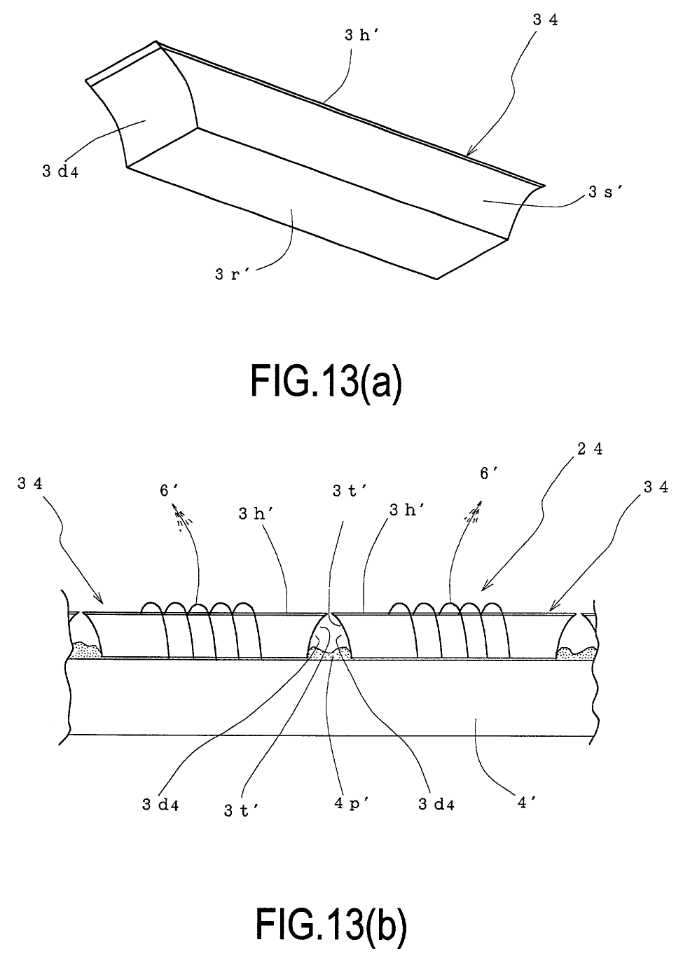

FIGS. 13(a) and 13(b) show the CCD sensor chip 34 that is the fourth embodiment and an image reading sensor 24 constituted from the CCD sensor chips 34 mounted on the sensor substrate 4′.

As shown in FIGS. 13(a) and 13(b), a CCD sensor chips 34 in the fourth embodiment have curved notched portions 3d4 having a continuous curved surface extending from the back side (mounting surface) 3r′ to the sensor surface 3h′, formed in the lower corners of the end portions 3t′ which face other adjacent CCD sensor chips 34 when mounted on the sensor substrate 4′.

The present embodiment has exactly the same constitution as the third embodiment, except for the notched portions 3d4 discussed above, and therefore the same reference numbers are used for other components than the notched portions and a detailed explanation is omitted.

The above-mentioned CCD sensor chips 34 are manufactured by the following method.

As in the third embodiment, the wafer 10′ that is the raw material for the CCD sensor chips 34 is prepared, and, as shown in FIG. 11(a), the pattern that will become the sensor surface 3h′ of the CCD sensor chips 34 is formed on the surface 10h′ of the wafer 10′.

Next, the back side 10r′ (the surface that will constitute the mounting surface of the CCD sensor chips 34) of the wafer 10′ is polished using a whetstone; and as shown in FIG. 11(b), a film t is adhered to the sensor surface 3h′ of the wafer 10′.

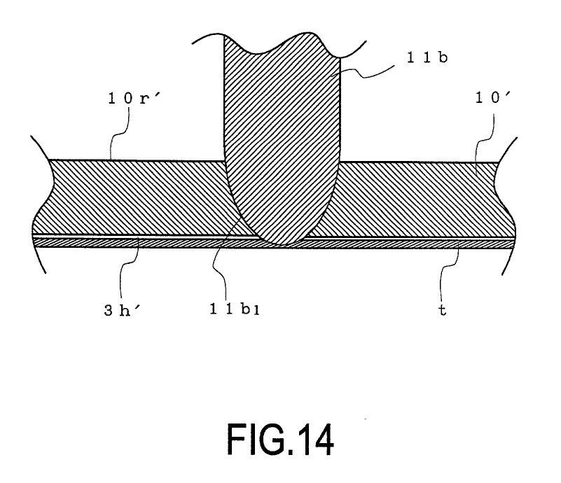

In order to form the curved notched portions 3d4 having a continuous curved surface extending from the back side 3r′ to the sensor surface 3h′ in the lower corners of the end portions 3t′ of the CCD sensor chips 34, as shown in FIG. 14, a cross sectional view taken perpendicularly to the cutting direction of a blade 11b and the wafer 10′ in the cutting process for the wafer 10′, the blade 11b having a cutting edge 11b1 with a curve-shaped cross section is prepared. Next, the wafer 10′ is divided into the CCD sensor chips 34 using the blade 11b to cut successively along prescribed cutting lines from the back side 10r′ of the wafer 10′, to which the film t is adhered, into the interior of the film t.

The film t is not cut completely through with the blade 11b in order to prevent the plurality of the CCD sensor chips 34 which have been cut apart from scattering around.

According to the present constitution, as shown in FIG. 13(b), even if the CCD sensor chip 34 receives the adhesive pressure from above during the adhesion operation in the manufacturing process and the die bonding paste 4p′ leaks from between the back side 3r′ (mounting surface) of the CCD sensor chip 34 and the sensor substrate 4′, the die bonding paste 4p′ will enter into and is held within the notched portion 3d4 formed in the CCD sensor chip 34. As a result, the die bonding paste 4p′ does not leak onto the sensor surface 3h′ of the CCD sensor chip 34.

Consequently, the die bonding paste 4p′ does not adhere to the reading pixels formed on the sensor surface 3h′ of the CCD sensor chip 34 and poor image readings by the CCD sensor chip 34 will not occur.

Also, because the notched portions 3d4 in the CCD sensor chips 34 are formed only in the lower corners of the end portions 3t′, and do not decrease the area of the back side 3r′ that is the mounting surface greatly, a sufficient area for adhesion to the sensor substrate 4′ is ensured and the strength of the adhesion of the CCD sensor chips 34 to the sensor substrate 4′ does not decrease.

Accordingly, the CCD sensor chips 34, the image reading sensor 24, and the copier (electronic device) including the image reading sensor 24 have the same merits as the merits explained for the first embodiment.

In addition, according to the manufacturing method for the CCD sensor chips 34 discussed above, the wafer 10′ is cut into the CCD sensor chips 34 by cutting from the back side 10r′ of the wafer using the blade 11b in the process for cutting the wafer 10′. As a result, the cutting operation in the manufacturing process is simplified and manufacturing costs are reduced.

Furthermore, since the blade 11b used in the cutting process has a cutting edge 11b1 having a curve-shaped cross section, the stress applied to the cutting edge 11b1 during the cutting is distributed relatively uniformly, and therefore the cutting edge 11b1 has high strength and a longer life span. As a result, the number of times the blade 11b has to be replaced is reduced and manufacturing costs are reduced.

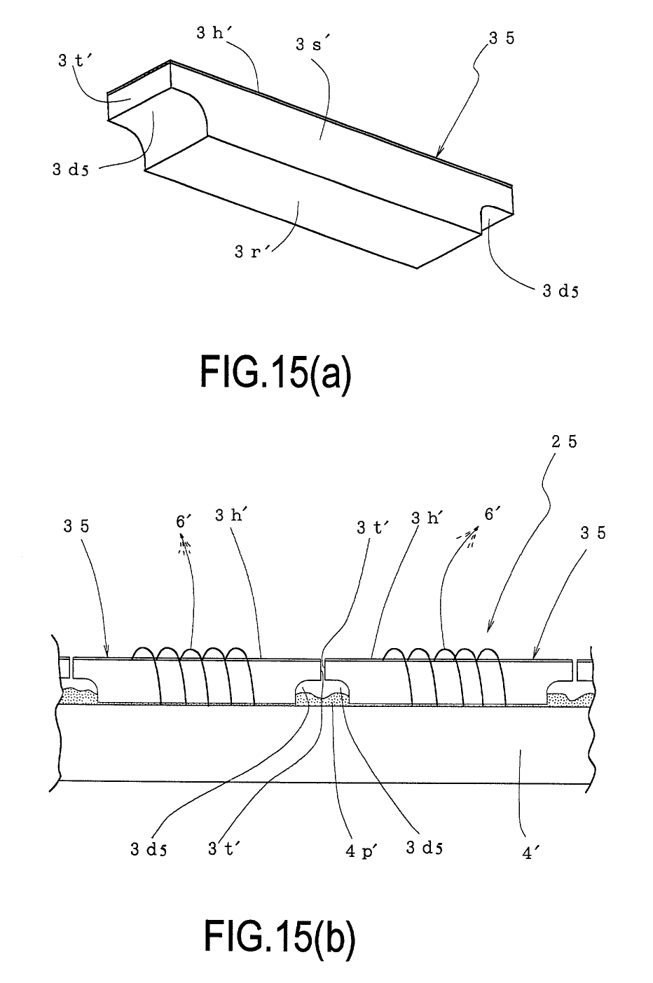

FIGS. 15(a) and 15(b) show a CCD sensor chip 35 that is the fifth embodiment and an image reading sensor 25 constituted from the CCD sensor chips 35 mounted on the sensor substrate 4′.

The fifth embodiment is a modification of the CCD sensor chip 3 and the image reading sensor 2 relating to the first embodiment shown in FIGS. 3(a) to 3(e) and FIGS. 4(a) and 4(b).

The CCD sensor chips 35 are provided with a step with two flat surfaces and a curved surface connecting the above-mentioned two flat surfaces in the lower corners of the end portions 3t′ which face other adjacent CCD sensor chips 35, and notched portions 3d5 are formed thereby.

In other words, a curved surface having a rounded cross section is formed at the inner corner at which the two flat surfaces intersect in the notched portion 3d5.

The present embodiment has exactly the same constitution as the first embodiment, except for the notched portions 3d5 discussed above, and therefore the same reference numbers as in the first embodiment with an apostrophe are used for the components other than the notched portions and a detailed explanation is omitted.

Likewise, the method for manufacturing the CCD sensor chips 35 is the same as the method for manufacturing the CCD sensor chips 3 in the first embodiment, except for performing the half cut dicing using a back side blade with a cutting edge having a curved corner with a rounded cross section. Consequently, an explanation of the manufacturing method is also omitted.

With the present constitution, even when stress is applied when the CCD sensor chips 35 are mounted on the sensor substrate 4′ or stress is applied to the CCD sensor chips 35 due to environmental changes and so forth during use after shipment as a finished product, a concentration of stress can be prevented from occurring because the inner corner where the two flat surfaces intersect is formed with a curved surface having a rounded cross section in the notched portions 3d5 formed in the CCD sensor chips 35.

The CCD sensor chips 35, the image reading sensor 25, and the copier (electronic device) including the image reading sensor 25 have the same merits as the merits explained for the first embodiment.

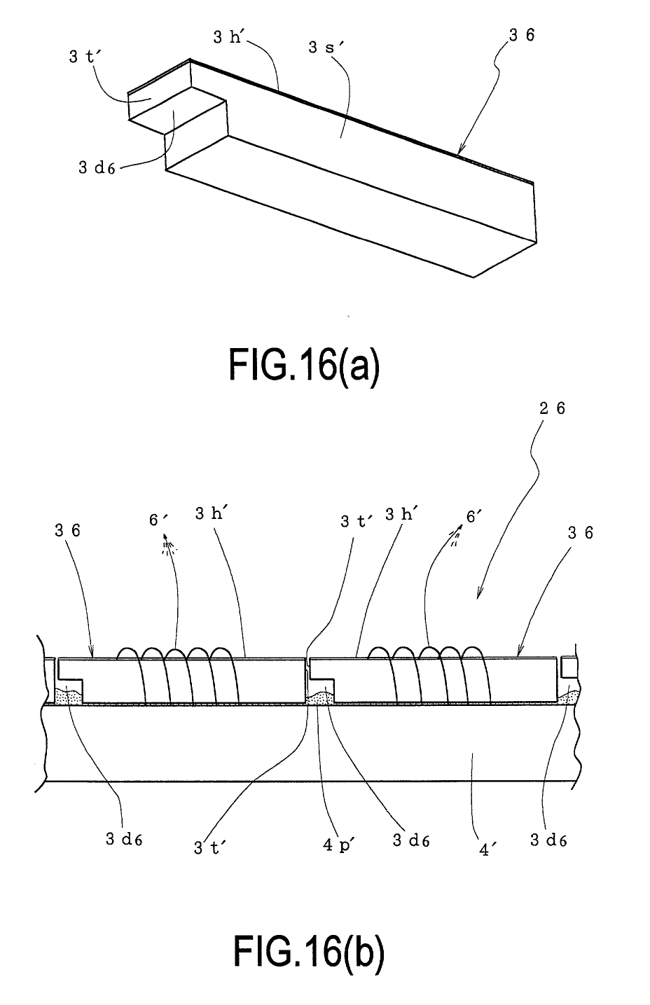

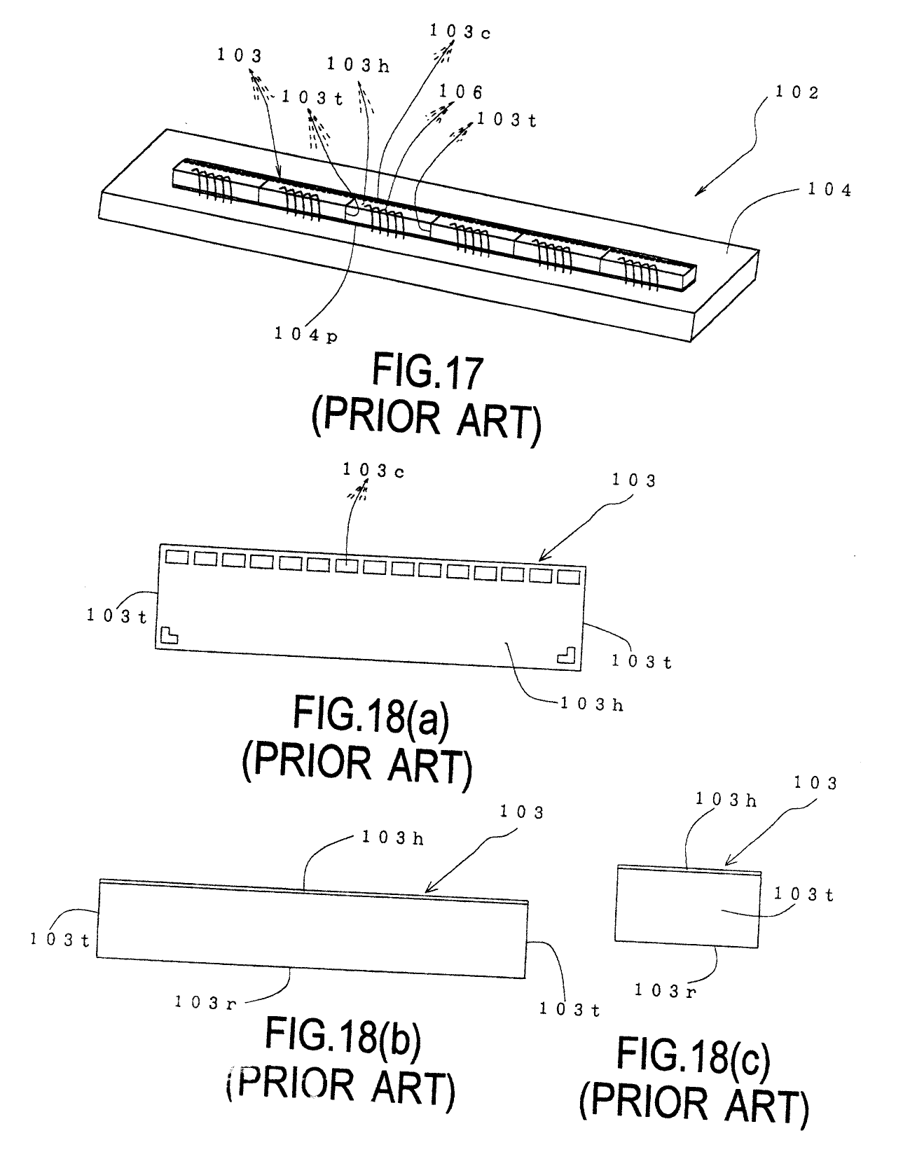

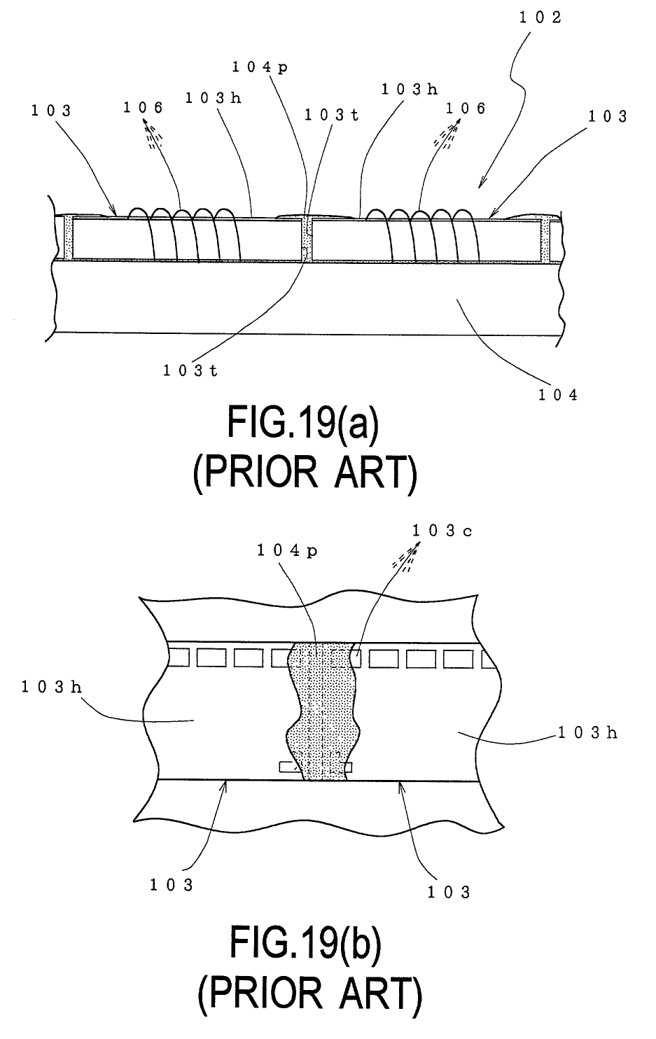

FIGS. 16(a) and 16(b) show a CCD sensor chip 36 that is the sixth embodiment and an image reading sensor 26 constituted from the CCD sensor chips 36 mounted on the sensor substrate 4′.

Like the fifth embodiment, the sixth embodiment is a modification of the CCD sensor chip 3 and the image reading sensor 2 relating to the first embodiment.

The CCD sensor chips 36 are provided with step-shaped notched portions 3d6 with two flat surfaces formed in the lower corner of one of the end portions 3t′ which face other adjacent CCD sensor chips 36.

The present embodiment has exactly the same constitution as the first embodiment discussed above, except for having the abovementioned notched portion 3d6 formed in the lower corner of only one of the end portions 3t′. Therefore the same reference numbers as in the first embodiment with an apostrophe are used for the components other than the notched portion and a detailed explanation is omitted.

Likewise, the method for manufacturing the CCD sensor chips 36 is the same as the method for manufacturing the CCD sensor chips 3 in the first embodiment, except for forming the notched portions 3d6 in the lower corner of the end portion 3t′ on one side. Therefore, an explanation of the manufacturing method is also omitted.

With the present constitution, the notched portions 3d6 in the CCD sensor chips 36 are formed only in the lower corner of the end portion 3t′ on one side and because the reduction in the area of the back side 3r′ which is the mounting surface of the CCD sensor chip 36 is very small, more than enough area for adhesion with the sensor substrate 4′ is ensured and the strength of adhesion of the CCD sensor chips 36 to the sensor substrate 4′ is not reduced.

As shown in FIG. 16(b), even if the CCD sensor chip 36 receives the adhesive pressure from above during the adhesion operation in the manufacturing process and the die bonding paste 4p′ leaks from between the back side 3r′ (mounting surface) of the CCD sensor chip 36 and the sensor substrate 4′, the die bonding paste 4p′ will enter into and be held within the notched portion 3d6 formed in the CCD sensor chip 36. As a result, the die bonding paste 4p′ will not leak onto the sensor surface 3h′ of the CCD sensor chip 36.

Consequently, the die bonding paste 4p′ does not adhere to the reading pixels formed on the sensor surface 3h′ of the CCD sensor chip 36 and poor image readings by the CCD sensor chip 36 will not occur.

Accordingly, the CCD sensor chips 36, the image reading sensor 26, and the copier (electronic device) including the image reading sensor 26 have the same merits as the merits explained for the first embodiment.

As discussed for the sixth embodiment in the above, the same effects as in the sixth embodiment are attained with the second through fifth embodiments by forming the notched portion in the lower corner of one end portion, of both end portions of the CCD sensor chip which face other CCD sensor chips.

In other words, the same effects as with the sixth embodiment are attained when a notched portion is formed in either one of the lower corners of the end portions of the two CCD sensor chips which are brought together, where one CCD sensor chip and another CCD sensor chip face each other.

The embodiments discussed above were explained using a CCD sensor chip as the sensor chip, however, it is possible to apply the sensor chip relating to the present invention to various other sensor chips. Likewise, it is possible to apply the image reading sensor relating to the present invention to image reading sensors comprising various other sensor chips.

Also, it is possible to effectively apply the electronic device relating to this invention to electronic devices including image reading sensors comprising various sensor chips other than the CCD sensor chips discussed above.

In addition, it is naturally possible to effectively apply the electronic device relating to this invention to various other electronic devices, besides copiers, such as OCR devices, facsimile machines and so one.

The entire disclosure of Japanese Patent Application No. 2000-86552 filed on Mar. 27, 2000 including specification, claims, drawings and summary are incorporated herein by reference.

What is claimed is:

1. A sensor chip which is rectangular in plane shape and has reading pixels on a surface, and which is constructed such that an image reading sensor is constituted by mounting a plurality of sensor chips in a straight line on a sensor substrate with an end portion of the sensor chip facing with an end portion of other sensor chip;
wherein a notched portion is provided at a lower corner of the end portion which faces other sensor chip.

2. The sensor chip according to claim 1, wherein the notched portion is formed to have two flat surfaces provided in the lower corner of the end portion.

3. The sensor chip according to claim 2, wherein the notched portion is formed to have a curved surface provided by connecting the two flat surfaces.

4. The sensor chip according to claim 1, wherein the notched portion is formed to provide one inclined surface provided at the lower corner of the end portion.

5. The sensor chip according to claim 1, wherein the notched portion is formed to have a continuous curved surface provided at the lower corner of the end portion.

6. An image reading sensor comprising a plurality of sensor chips, each of which is rectangular in plane shape and has reading pixels on a surface thereof, mounted in a straight line on a sensor substrate with an end portion of the sensor chip facing with an end portion of other sensor chip;
wherein a notched portion is provided at a lower corner of the end portion of the sensor chip which faces other sensor chip.

7. The image reading sensor according to claim 6, wherein the notched portion in the sensor chip is formed to have two flat surfaces provided at the lower corner of the end portion.

8. The image reading sensor according to claim 7, wherein the notched portion in the sensor chips is formed to have a curved surface provided by connecting the two flat surfaces.

9. The image reading sensor according to claim 6, wherein the notched portion in the sensor chips is formed to have one inclined surface provided at the lower corner of the end portion.

10. The image reading sensor according to claim 6, wherein the notched portion in the sensor chips is formed to have a continuous curved surface provided at the lower corner of the end portion.

11. An electronic device containing an image reading sensor comprising a plurality of sensor chips, each of which rectangular in plane shape and has reading pixels on a surface thereof, mounted in a straight line on a sensor substrate with an end portion of the sensor chip facing with an end portion of other sensor chip;
wherein a notched portion is provided at a lower corner of the end portion of the sensor chip which faces other sensor chip.

12. The electronic device according to claim 11, wherein the notched portion in the sensor chip constituting the image reading sensor is formed to provide two flat surfaces established in the lower corner of the end portion.

13. The electronic device, according to claim 12, wherein the notched portion in the sensor chip constituting the image reading sensor is formed to have a curved surface provided by connecting the two flat surfaces.

14. The electronic device according to claim 11, wherein the notched portion in the sensor chip constituting the image reading sensor is formed to have one inclined surface provided at the lower corner of the end portion.

15. The electronic device according to claim 11, wherein the notched portion in the sensor chip constituting the image reading sensor is formed to have a continuous curved surface provided at the lower corner of the end portion.
